(19) United States
(12) Patent Application Publication
(10) Pub. No.: US 2022/0245522 A1
(43) Pub. Date: Aug. 4, 2022

(54) COMPRESSION AS A SOLUTION FOR CONGESTION CONTROL ON AI WORKLOADS

(71) Applicant: Intel Corporation, Santa Clara, CA (US)

(72) Inventors: Aswin RAMACHANDRAN, Austin, TX (US); Amedeo SAPIO, San Jose, CA (US); Steven C. MILLER, Livermore, CA (US)

(21) Appl. No.: 17/723,216

(22) Filed: Apr. 18, 2022

(51) Int. Cl. G06N 20/00

(52) U.S. Cl. CPC G06N 20/00

(57) ABSTRACT

Methods and apparatus for employing selective compression for addressing congestion control for Artificial Intelligence (AI) workloads. Multiple interconnected compute nodes are used for performing an AI workload in a distributed environment, such as training an AI model. Periodically, such as following an epoch for processing batches of training data in parallel, the compute nodes exchange Tensor data (e.g., local model gradients) with one another, which may lead to network/fabric congestion. Compute nodes and/or switches in the distributed environment are configured to detect current or projected network/fabric congestion and to selectively apply variable rate compression to packets containing the Tensor data to alleviate/avoid the congestion. Tensor data may be selectively applied at source compute nodes by computing a network pause time and comparing that time to a compression compute time. Switches may selectively compress packets to be forwarded to destination compute nodes based on buffer/queue fill levels and/or other network telemetry data.

### BACKGROUND INFORMATION

In recent years machine learning (ML) and artificial intelligence (AI) have become increasing more powerful and complex, enabling tasks such as massively scaled real-time voice-to-text natural language processing (e.g., Alexa, Siri, etc.) and autonomous vehicles to enter the mainstream. Historically, ML and AI models employed ML algorithms and frameworks that were generally deployed using central processing units (CPUs) on a single machine or a small number of machines. With advancements in hardware to support large artificial neural networks (ANNs) and so-called “deep learning” (e.g., Graphic Processing Units (GPU) targeted to ML/AI, Tensor Processing Units (TPUs), CPUs with AI cores, Infrastructure Processing Units (IPUs), Data Processing Units (DPUs), Field Programmable Gate Arrays (FPGAs) and other forms of accelerators), ML and AI models are being used to tackle problems that were not viable just a few years ago.

In addition to scaling using advanced hardware, ML and AI models may be scaled using distributed processing across multiple platforms, sometimes referred to as “nodes” or “compute nodes.” Under a distributed model, performance may be adversely affected by network congestion. For example, network congestion leads to performance loss in AI model training as the traffic in the network is dropped, throttled, or paused for a duration and then, the data is retransmitted. This is especially problematic in large-scale AI model training clusters, as the switched network traffic gets constrained during the model-to-model data communication phases.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a diagram of a simple artificial neural network (ANN);

FIG. 2 is a diagram illustrating training a machine learning or artificial intelligence model using a distributed process under which two compute nodes coupled via a switch implement instances of the ANN of FIG. 1;

FIG. 3 is a process flow diagram that is implemented by each of the compute nodes in FIG. 2.

FIG. 4 is a is a schematic diagram of an exemplary AI compute node cluster communicatively coupled via a network or fabric;

FIG. 5a is a schematic diagram illustrating an example of a distributed compute node environment in which compute nodes are deployed in racks with respective Top of Rack (ToR) switches that are coupled via peer to peer links;

FIG. 5b is a schematic diagram illustrating a variation of the example of a distributed compute node environment example of FIG. 5a under which the ToR switches are connected to a Pod switch in a switch hierarchy;

FIG. 6 is a schematic diagram of an AI compute system including 8 compute nodes coupled to an internal switch;

FIG. 7 is a diagram illustrating cost/benefit tradeoffs when employing Tensor compression in a distributed training environment;

FIG. 8 is a block diagram of compression trigger logic, according to one embodiment;

FIG. 9 is a diagram illustrating a high level view of a distributed AI model training system under which a portion of Tensor data is compressed;

FIG. 10 is a flow diagram illustrating flows for calculating a time for 1 iteration with compression and for estimating compute device pause times during model training using NIC network telemetry data, according to one embodiment;

FIG. 11 is a flow diagram illustrating operations and logic for performed by a check to determine whether the network pause time is greater than the compute time for compression, according to one embodiment;

FIG. 12 is a diagram of a switch configured with circuitry and logic for implementing aspects of the programmable networking device/switch embodiments disclosed herein;

FIG. 13 is a flowchart illustrating operations and logic for performing selective compression in a switch;

FIG. 14 is a diagram of a switch performing a message broadcast with compression;

FIG. 15 is a diagram illustrating selection of a compression scheme to be used for compressing Tensor data;

FIG. 16 is a flowchart illustrating operations and logic for implementing compression using fixed representation with a compression ratio, according to one embodiment; and

FIG. 17 is a flowchart illustrating operations for implementing topK or Low rank compression in-line as part of the Tensor data exchange, according to one embodiment.

### DETAILED DESCRIPTION

Embodiments of methods and apparatus for employing selective compression for addressing congestion control for AI workloads are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

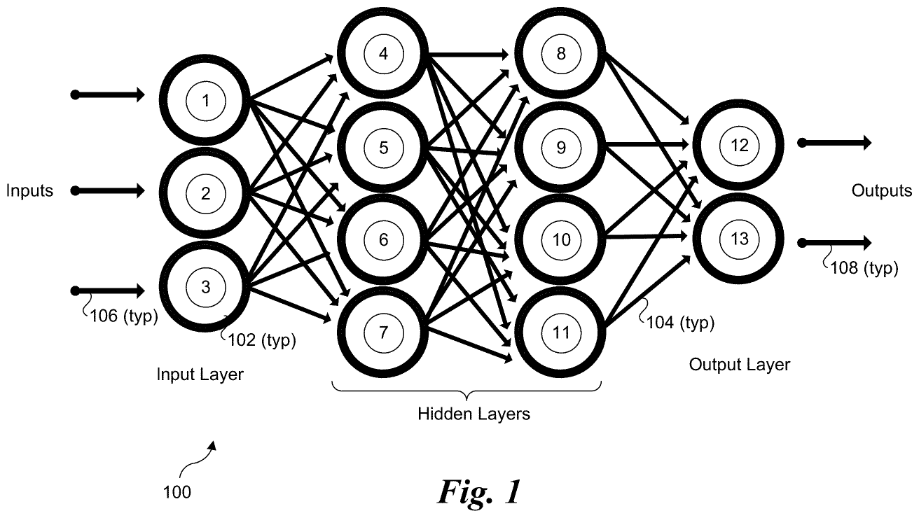

An artificial neural network (ANN), commonly referred to as a neural network, is a computational nonlinear model based on the neural structure of the brain that is able to learn to perform tasks like classification, prediction, decision-making, visualization, and others through the use of training examples. An ANN is composed of artificial neurons called nodes interconnected by connections or “edges”, where the nodes represent the brain's neurons and the edges represent synapses. FIG. 1 shows an illustration of a simple ANN 100 composed of a plurality of nodes 102 arranged in layers and interconnected via edges 104. As shown in FIG. 1, the layers include an input layer with the nodes labeled ‘1’, ‘2’, and ‘3’, two hidden layers with four nodes each labeled ‘4’, ‘5’, ‘6,’ ‘7’, ‘8’, ‘9’, ‘10’, and ‘11’, and a pair of nodes in the output layer labeled ‘12’ and ‘13’. This is example of a multi-layer perceptron (MLP) which comprises a fully connected network using a feedforward topology under which each node in a given layer is connected to each node in the adjacent layers. Other types of ANNs, such as recurrent neural networks (RNNs), allow connections between neurons in the same or previous layers. There are also various ANN topologies where nodes between adjacent layers are not fully connected.

Data is provided as inputs 106 to nodes ‘1’, ‘2’, and ‘3’ in the input layer. The input data are usually structured in a table format or a dataframe, such as a Pandas dataframe used in Python, noting several other languages may also be used. Generally, the number of columns of the table/dataframe matches the number of neurons in the input layer, unless the input dataframe also includes one or more classification columns. In this simplified example, each row of input data would include three values. For training data for a classification model employing supervised learning, one or more separate columns are used for classification, either using the same dataframe or a separate dataframe only including the classification columns. For a binary classification, there would be a single column containing values of ‘1’ and ‘0’. Image classification may include a range of classification values for a single value (e.g., dog or cat) to many classification values. There are also types of ANNs used for tasks such as natural language processing (NLP) that use different network topologies such as Long short-term memory (LSTM), a type of RNN.

In a biological brain, signals are sent between neurons via the synapses. Likewise, in an ANN, signals are sent between nodes via the edges. An ANN is a computational model that operates on numerical data; in particular, that data are floating point numbers. The signals, which are floating point values are computed by a “activation” function implemented by a node as a sum of its input (applied to that function). Non-limiting examples of activation functions include a linear function, a step function, a logistic (Sigmoid) function, a hyperbolic tangent (Tanh) function, and a Rectified linear unit (ReLu) function.

Except for nodes in the output layer, the output of the activation function for a given node comprises a “weight” that is provided along the edges to each of the nodes in the next layer that are connected to that node. Nodes in an output layer often implement a “softmax” function, which takes an input vector z of K real numbers (where K is the number of input edges) and normalizes it into a probability distribution consisting of K probabilities proportional to the exponentials of the input numbers.

For a classification model, the objective is to correctly predict a class of an input. For example, for optical character recognition for zip codes, the output layer comprises 10 nodes respectfully representing digits (classes) 0-9, each with a binary output of ‘0’ or ‘1’ based on the probability distribution. The threshold for determining whether an output is a ‘0’ or ‘1’ is one of many model “hyperparameters” that can be adjusted.

The model is trained during a learning or training phase using a training set of inputs. Learning involves adjusting the weights (and optional thresholds) of the network to improve the accuracy of the output, and is done by minimizing observed errors in the training set predictions. Models may use a cost function, such as in a probabilistic model the model's posterior probability can be used as an inverse cost. Various types of cost functions may be used.

An MLP employs backpropagation to train the network. Backpropagation is a method used to adjust the connection weights to compensate for errors found during learning. The error amount is effectively divided among the connections. Backpropagation calculates the gradient (the derivative) of the cost function associated with a given state with respect to the weights. The weight updates can be done via stochastic gradient descent or other methods. For illustrative purposes herein, stochastic gradient descent (or simply “gradient descent”) is used.

Training is performed over a number of “epochs,” which is another hyperparameter that may be adjusted. During each epoch, the input training set is evaluated. Since training sets may be large (or enormous for some problems), a batched approach is often used. In this case, the training set is divided into subsets of training data called “batches” and the batch sets are processes using the number of epochs that is set. After a given batch has been processed, the next batch is processed until all the training data has been processed.

During a given epoch, errors are observed resulting in gradient descent values. Following the given epoch, the weights are adjusted using backpropagation using the gradient descent values. The amount of adjustment per epoch is usually based on a learning rate defines the size of the corrective steps that the model takes to adjust for errors in each observation. Various ML and AI frameworks provide output to observed prediction rates and other observed data, such as projected error rates. For a given batch and properly designed model, the error rate will converge, generally up to some point where additional epochs do not reduce the error rate on a consistent basis and/or may actually increase somewhat. Some models use one or more output criteria as hyperparameters rather than a fixed number of epoch, where the batch of data is processed a variable number of epochs until the output criteria is/are met.

At the beginning of processing the first batch, the weights may be set using random values or the weights may be preset. Also, some models may use bias inputs for some nodes. The use of biases provides a means for adjusting the thresholds of activation functions that employ thresholds.

Distributed processing enables the training data to be processed by multiple “compute” nodes in parallel. The use of the term compute nodes herein is to distinguish the nodes that are performing the processing (computations) for nodes in the ANN. A compute node provides some form of computation, such as a central processing unit (CPU) or Graphics Processing Unit (GPU) that is used to execute code to implement the ML or AI algorithm(s). Other types of compute nodes include but are not limited to Tensor Processing Units (TPUs), AI processors, and AI inference units, each of which represent specialized hardware that is designed for processing ML/AI algorithms. For illustrative purposes, the compute nodes shown and discussed herein are generically represented as boxes or blocks, with the recognition that both homogeneous and heterogeneous compute nodes may be used in a distributed system.

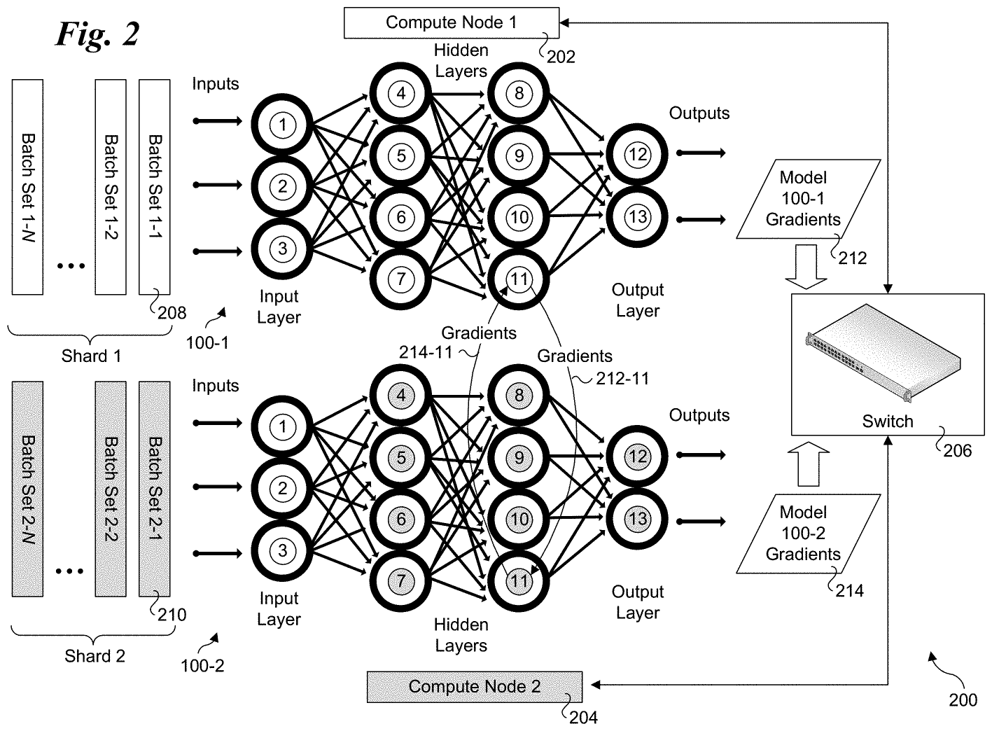

ML/AI models may be processed by distributed systems using data parallelism, model parallelism, or a combination of the two. A simple example of data parallelism is shown in FIG. 2, which shows a distributed system 200 including a pair of compute nodes 202 and 204 connected in communication via a switch 206. As shown, a model 100-1 comprising a first instance of ANN 100 of FIG. 1 is implemented on compute node 202, while a model 100-2 comprising a second instance of ANN 100 is implemented on compute node 204. Compute node 202 processes a first sequence N batch sets collectively containing a first half of the overall training data (comprising a first shard 1), beginning with a batch set 208. Similarly, compute node 204 processes a second sequence Nbatch sets collectively containing the second half of the overall training data (comprising a second shard 2), beginning with a batch set 210. Batch sets 208 and 210, along with respective pairs of subsequent batch sets are processed in parallel, wherein each batch set is processes either a predefined number of epochs or until an error threshold is reached.

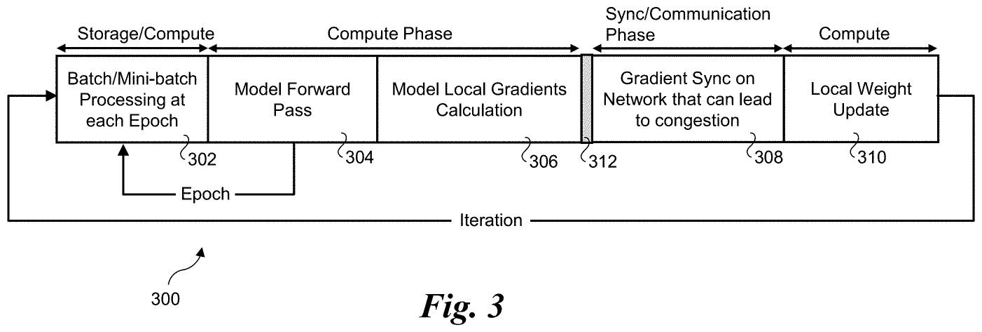

FIG. 3 shows a process flow diagram 300 that is implemented by each of compute nodes 202 and 204. The overall process involves four phases that are used during processing of a batch or mini-batch of training data. A round of batch or mini-batch processing is referred to as an iteration, is depicted by the outer loop in the diagram.

As depicted in a block 302, batch or mini-batch processing at each epoch is performed during a storage/compute phase. During the first portion of the compute phase, a forward pass of the model is performed in a block 304 for each epoch, with the operations in blocks 302 and 304 being repeated a predetermined number of epochs or when a tunable error threshold is reached. Following the batch/mini-batch training, calculation of local gradients for the model are performed in a block 306. The local gradients comprise Tensor data that will be exchanged amongst the compute nodes performing distributed ML/AI model training.

At this point a synchronization operation is performed under which the local gradients that were calculated in block 306 are exchanged among the compute nodes (e.g., each compute node sends a copy of its gradients for the model and for the iteration to each of the other compute nodes participating in the distributed system). Following a sync state 308, the exchange of local model gradients is performed during a sync/communication phase during which network congestion may occur, as depicted in a block 310. The sync state is used to ensure all the compute nodes have completed their compute phase, observing that even when using homogeneous compute nodes the length of compute phases may vary for different dataset batches or mini-batches. After the gradient data are exchanged, during a brief compute phase each compute node combines the gradient data that are received from the other compute nodes with its own gradient data to update the weights in its local model, as depicted in a block 312.

Aspects of process flow diagram 300 are illustrated in FIG. 2. Generally, the batch sets may be initially stored on a local drive (e.g., solid state drive (SSD) or magnetic disc drive) or be stored on a separate storage device or storage devices and loaded over a network. For very large datasets that are processed using a moderate to large number of distributed compute nodes, respective portions of the overall training data may be pushed or downloaded from a repository or the like by respective compute nodes in advance. The portion each compute node works on may be pre-batched (when downloaded), or batching may be performed on the compute node following the download. Under a system employing broadcasting/scatter/gather messages, such as using Message Passing Interface (MPI) collectives, an MPI Scatter collective may be used to push separate portions of the overall training set to respective compute nodes. Under any of these scenarios, at some point one or more batches (or mini-batches) are loaded into local memory on each compute node.

During each epoch, the training data the current batch is processed using a feedforward process (model forward pass block 304), beginning with the input layer, proceeding through the one or more hidden layers, followed by the output layer. During each epoch, local gradients for the model will be calculated in block 306. During the sync communication phase, the gradient data are exchanged. In distributed system 200 there are only two compute nodes and they exchange their local model gradient data with one another, as depicted by model 100-1 gradients 212 sent from compute node 202 to compute node 204, and model 100-2 gradients 214 send from compute node 204 to compute node 202.

The local gradient data are stored (in the model) using a data structure(s) that stores an applicable set of gradients per node for all the model nodes except the output layer nodes. For illustrative purposes, FIG. 2 shows local gradients 212-11 and 214-11 for node 11 in models 100-1 and 100-2 being exchanged. Similar gradient data for the other nodes in models 100-1 and 100-2 would be included in model 100-1 gradients 212 and model 100-2 gradients 214.

Once a given compute node as received the gradient data from the other nodes it updates the weights used for its local model. Thus, in the example of FIG. 2, compute node 202 would employ is own local gradients 212 and local gradients 214 received from compute node 204 to update the weights used for model 100-1. Likewise, compute node 204 would employ is own local gradients 214 and local 212 received from compute node 202 to update the weights used for model 100-2. The process would then return to process the next epoch. It is noted for a given batch data set the data would be loaded into memory prior to the first epoch and remain in memory until processing for that batch data set is completed, at which point the next batch data set would be loaded into memory and processed (if not previously loaded into memory).

Actual ML/AI models will generally be more complex that that shown in FIG. 2, and distributed systems used for processing ML/AI models may employ 10's, 100's or even 1000's of nodes. Some ML/AI models may be extremely complex, such as models used for language processing using transformer-based neural networks. For example, a recent AI language model implemented by Google® has 1.6 trillion parameters. Meanwhile, Microsoft has developed a Turning Natural Language Generation (Turing-NLG) model that can be scaled across supercomputers with thousands of GPUs.

Both model complexity and distributed network size are problematic for handling the sync/communication phase. For example, consider the foregoing data parallelism example. As the model complexity grows, the amount of gradient data that needs to be transferred between compute nodes increases. The problem is exacerbated when the number of compute nodes is increased, as the traffic goes up approximately exponentially as a function of the number of nodes (N*(N−1)).

There are various distributed architectures that may be employed for large scale ML/AI models. These generally include nodes that are interconnected by one or more levels of switches in a switch hierarchy. Let's considerer a few examples.

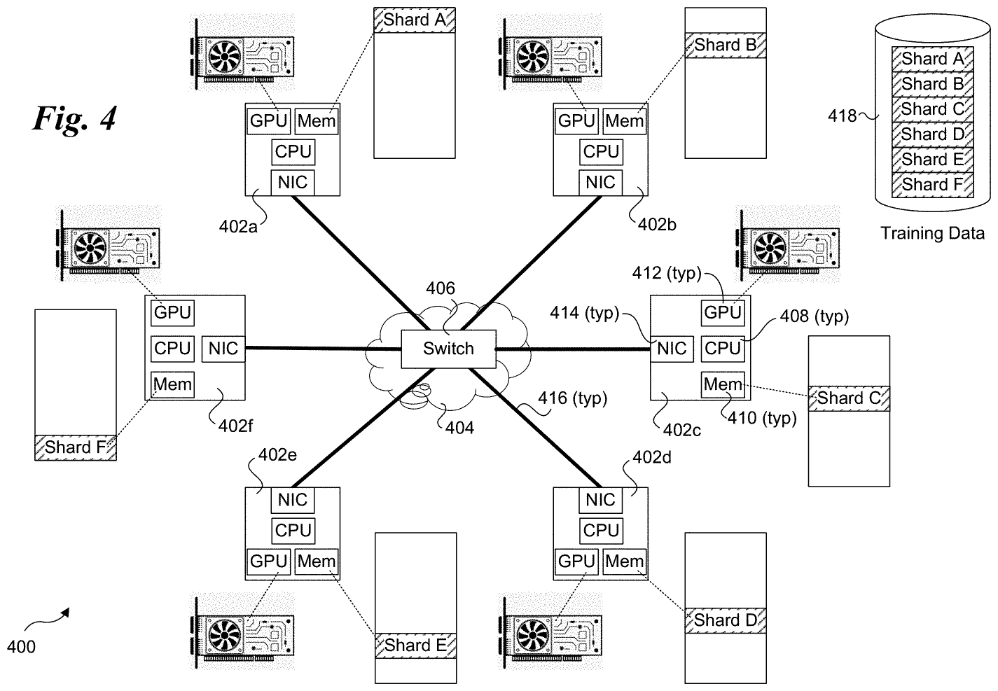

FIG. 4 shows an example of a small compute node cluster 400 illustrative of more generalized environments in which aspects of the embodiments disclosed herein may be implemented. Compute node cluster 400 is illustrative of a conventional network environment under which multiple servers comprising compute nodes 402a, 402b, 402c, 402d, 402e, and 402f are coupled in communication over a network or fabric 404 including a switch 406. As further shown, each compute node 402 includes a CPU 408, memory 410, a GPU card 412 and a Network Interface Controller (NIC) 414 that is coupled to switch 406 via a link 416. Compute nodes may also include local storage devices such as SSDs (not shown in FIG. 4).

Generally, network 404 may employ various types of physical links and related protocols, including but not limited to Ethernet, InfiniBand, Compute Express Link (CXL) and Peripheral Control Interconnect Express (PCIe). For networks or fabrics that do not employ Ethernet, NICs 414 would be replaced with an applicable network or Input-Output (TO) interfaces, such as InfiniBand Host Control Adaptors (HCAs) for an InfiniBand, CLX interfaces for CLX, PCIe interfaces for PCIe, etc.

As discussed above, for data parallelism, different batches of training data are processed using the same ML/AI model on different compute nodes. In this example, there are six compute nodes 402a, 402b, 402c, 402d, 402e, and 402f that are used to process respective shards A, B, C, D, E, and F, which collectively comprise the entire training data stored in a repository 418. As described above, the shards would be distributed to the compute nodes in advance. Moreover, shards A, B, C, D, E, and F may be partitioned into multiple batches that are processed in parallel during each round of epochs.

Compute node cluster 400 employs a star configuration under which each compute node server or platform is coupled directly to a common switch via a respective link. As described an illustrated below, a network switch (such as a switch in an Ethernet network) includes a plurality of input-output (TO) ports to which a wired or optical cable is coupled on the switch side of the link. Sets of ingress and output buffers/queues are operatively coupled respective IO ports for buffering packets that are received at an IO port (the ingress port) and for buffering packets to be sent out another IO port (the egress port). For a given IO port, received packets are buffered in one or more ingress queues (e.g., First-in First-out (FIFO) queues) allocated for that IO port. Similarly, outbound packets are buffered in one or more egress queues allocated for a given IO port.

When an ingress packet reaches the top of the queue, logic in the switch inspects the packet header to determine what its destination address is. For Layer 3 Ethernet switches, the packet headers include source and destination Internet Protocol (IP) addresses. Layer 2 Ethernet switches, which might be implemented in data centers and server farms using Layer 2 Media Access Channel (MAC) addresses. The switch will employ a routing table or the like to determine the next “hop” in a forwarding path used to reach the destination address and move the packet from the ingress queue to an egress queue for the IO port coupled to the link that will reach the next hop. Under compute node cluster 400, the next hop and the destination are the same; as described and illustrated under the dragonfly topology below, the next hops and destinations may be different.

In addition to routing/forwarding packets, switches may also be used for flow control and implement different levels of Quality of Service (QoS). For example, QoS may be implemented for selected packet flows by enqueuing packets for those flows in separate egress queues that are given priority over other egress queues for the same IO port, such as by using weight round-robin arbitration amongst the egress queues for that IO port.

In some environments, compute nodes will be dedicated for a given task, such as processing batches of training data as part of distributed training using data or model parallelism. Thus, the traffic to and from such compute nodes may be somewhat predictable and or synchronized. When compute nodes are used to concurrently perform for than one task or workload, the network traffic may be less predictable and asynchronous.

Switches maintain metadata relating to ingress and egress buffer/queue fill levels. The buffers/queues have finite sizes and may approach or reach an overfill state, which may or will result in packets being dropped. For example, if all the ingress queues for a given IO port are full, subsequent received packets will be dropped. Similarly, if the egress queues for a given IO port are full, a packet being forwarded/routed may be dropped.

Switches have various mechanisms for preventing or reducing the likelihood of dropped packets. Under reliable transport protocols, such as TCP (Transmission Control Protocol)/IP, the protocol provides mechanisms to ensure packets (and their data) are reliably delivered to destinations without errors. In one aspect, the destination monitors for received data segments transmitted via packets using associated sequence numbers. Periodically, when a sequence of data segments has been successfully received without error be a destination, the destination will return an ACKnowledgement (ACK) to the sender to inform the sender it does not need to resend any packets containing those data segments. TCP has a timeout mechanism under which a TCP sender will retransmit data segments for which it has not received ACKs for within a timeout period. TCP also uses one or more network congestion-avoidance algorithms to avoid traffic congestion, such as slow start schemes, backoff schemes, and schemes employing congestion windows. These mechanisms are implemented at the TCP endpoints (sender (source) and destination).

Data centers may employ additional mechanisms to avoid/prevent congestion, such as flow-control techniques like priority flow control (PFC), DCQCN (Data Center Quantized Congestion Notification) for RoCEv2 (Remote Direct Memory Access (RDMA) over Converged Ethernet, version 2), and DCTCP, which is a modified version of TCP implemented in data centers that leverages Explicit Congestion Notification (ECN) to provide multi-bit feedback to end hosts. Unlike conventional TCP, these congestion avoidance mechanisms are implemented, at least in part, in the data center switches.

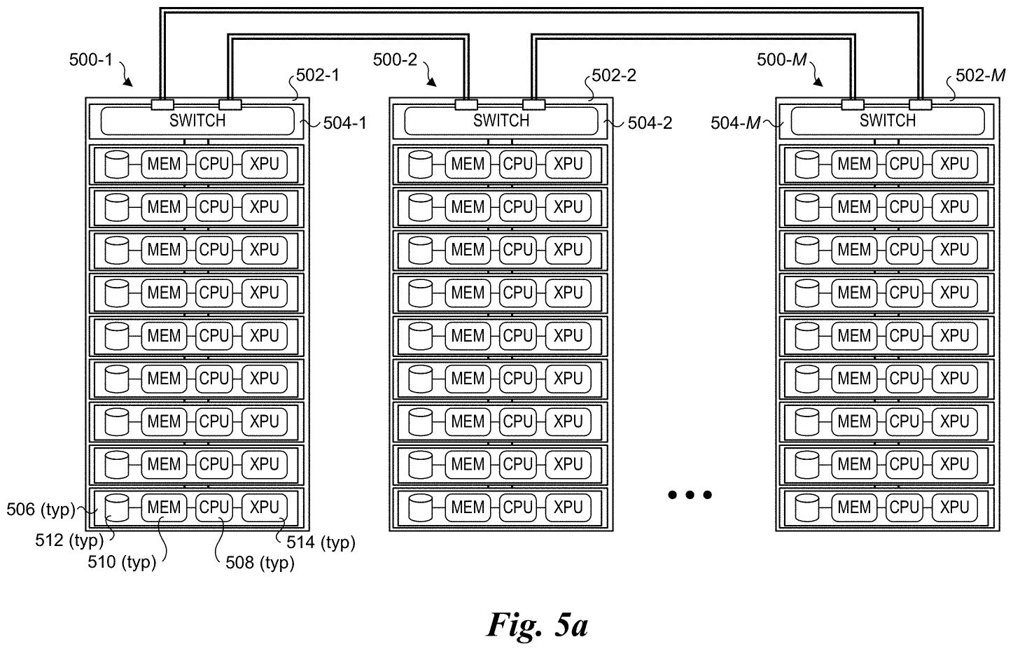

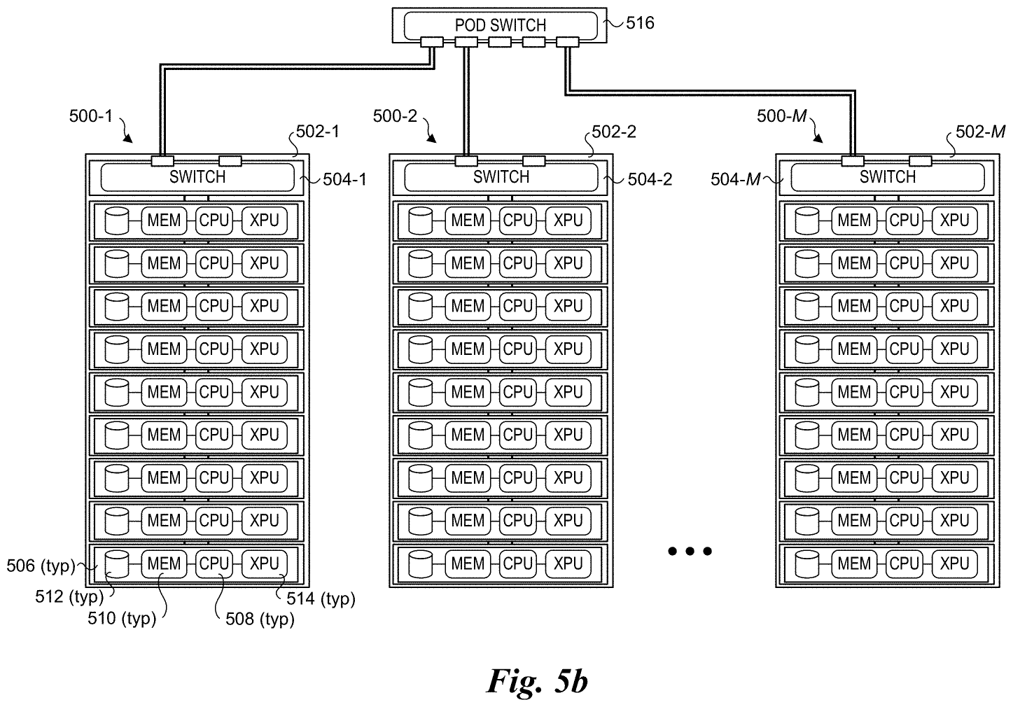

FIGS. 5a and 5b illustrating examples of switch configurations in a data center environment that includes M compute node clusters 500-1, 500-2 . . . 500-M deployed in respective racks 502-1, 502-1 . . . 502-M, where each rack has a respective Top of Rack (ToR) switch 504-1, 504-1 . . . 504-M Each of these racks further is populated with multiple compute nodes 506, each including a CPU 508, memory 510, storage 512 and an XPU 514. As used herein, XPUs refer to Other Processing Units which may include one or more of Graphic Processor Units (GPUs) or General Purpose GPUs (GP-GPUs), Tensor Processing Units (TPUs), Data Processor Units (DPUs), Infrastructure Processing Units (IPUs), Artificial Intelligence (AI) processors or AI inference units and/or other accelerators, FPGAs and/or other programmable logic (used for compute purposes), etc. In one embodiment compute nodes 506 have a similar configuration with compute nodes 402a-f shown in FIG. 4 and discussed above, including a NIC or other network or fabric interface that is not separately shown in FIGS. 5a and 5b to save space.

Generally, the compute nodes may comprise platforms having various form factors such as server blades, 1U, 2U and 4U servers, servers installed in “sleds” and “trays,” etc. Additionally, a compute node used for AI/ML processing may comprise a GPU or GPU card, a TPU or TPU card, or other forms of XPUs or XPU cards. Generally, server blades and server modules are installed in chassis or “drawers” that are installed in racks. Likewise, 1U, 2U, and 4U servers and trays are installed in racks. Cabinet installations may also be used. XPUs may be included on a main board or daughter board of a server or other platform. XPU cards will usually be installed in an IO expansion slot (e.g., PCIe slot) in a server/platform.

For illustrative purposes presume that each of compute nodes 506 is installed in a respective slot in racks 502-1, 502-1 . . . 502-M. The NIC or other network or fabric interface for each compute node is coupled to a port in the ToR switch 504 for a given rack using a wired or optical cable or the like. Under the architecture shown in FIG. 5a, each of switches 504-1, 504-2 . . . 504-M is coupled to at least two other switches via at least one link between each pair of switches. In one embodiment, the switches a full mesh is formed where each switch is coupled to each other switch. This configuration may be used to support various topologies including a “dragonfly” topology.

The architecture of FIG. 5b employs a switch hierarchy that includes a Pod switch 516, and wherein racks 500-1, 500-2 . . . 500-M comprise a Pod. In this architecture, each of switches 504-1, 504-2 . . . 504-M is coupled to pod switch 516 via at least one link (only one of which is shown in FIG. 5b). In addition to the architectures shown in FIGS. 5a and 5b, a hybrid approach may be used that employs a combination of a switch hierarchy and peer-to-peer switch connections.

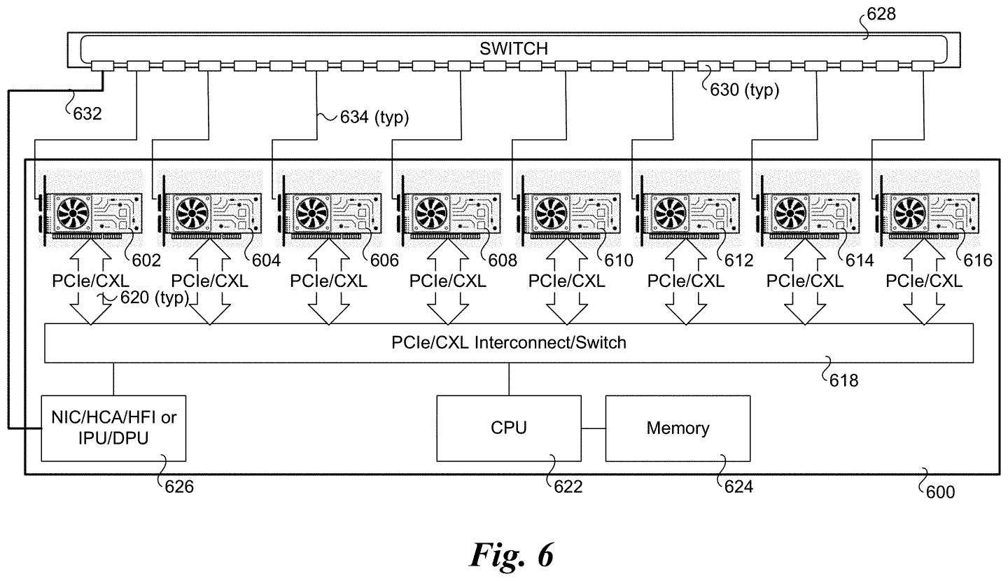

FIG. 6 shows an AI system 600 including 8 compute nodes 602, 604, 606, 608, 610, 612, 614, and 616. In the illustrated example, each of these compute nodes comprise a GPU card that includes a GPU and on-board memory (e.g., 4+GB of memory). Optionally, the GPUs may be implemented on other form factors, such as mounted to a main board or on daughterboards or the like. The compute nodes 602, 604, 606, 608, 610, 612, 614, and 616 are coupled to a PCIe or CXL interconnect/switch 618. For some embodiments PCIe or CXL interconnect/switch 618 will comprises a plurality of expansion slots in which respective GPU cards are installed. AI system 600 also includes a CPU 622, memory 624, and an NIC/HCA/HFI or IPU/DPU 626, which may be any of an Ethernet NIC, InfiniBand HCA, Host Fabric Interface, or an IPU or DPU.

Generally, AI system 600 may be housed in a cabinet or chassis that is installed in a rack (not separately shown). Also installed in the rack is a ToR switch 628 including a plurality of ports 630. One or more ports for NIC/HCA/HFI or IPU/DPU 626 are coupled via respective links (one of which is shown) to a port on ToR switch 628. As an option, each of compute nodes 602, 604, 606, 608, 610, 612, 614, and 616 includes an applicable network or fabric interface that is coupled to a respective port 630 on ToR switch 628 via a respective link 634.

In some embodiments, an AI system may include multiple internal switches that provide interconnection between the compute nodes in the system. Also, an AI system may employ a “disaggregated” switch, such as but not limited to a disaggregated PCIe or CXL switch. Disaggregated here means the switch is separate from the ToR (or other switches) in the data center racks.

As described and illustrated above, following a sync operations local gradient data is exchanged between compute nodes working on distributed model training. Under the various compute node and switch architectures illustrated herein, as well as other compute node/switch architectures, the exchange of the local gradient data may create too much traffic for one or more switch paths. The conventional traffic congestion avoidance solutions in such environments, such as PFC, DCQCN, and DCTCP, may result in substantial performance degradation. For example, The PFC and DCQCN have buffer limitation after which the pause frames are sent to throttle the source traffic. Hence, during large in-casts or at high IOPS (TO operations per second) they prevent network congestion by reducing or pausing the traffic. In addition, careful dead-lock avoidance measures should be taken while using these techniques. Hence, not all networks have flow-control turned-on.

In accordance with aspects of the solutions provided herein, variable compression of exchanged model data, such a local gradient data, is used to avoid network congestion based on real-time and/or projected network congestion levels. For example, congestion may be detected using various components in the system, such as tracking local NIC events and leveraging congestion notifications generated by switches. In one aspect, variable compression ratios are used to compress the gradient data based on hardware network events to prevent network congestion. Generally, various types of data compression algorithms and technique may be used that factor in the hardware network congestion events.

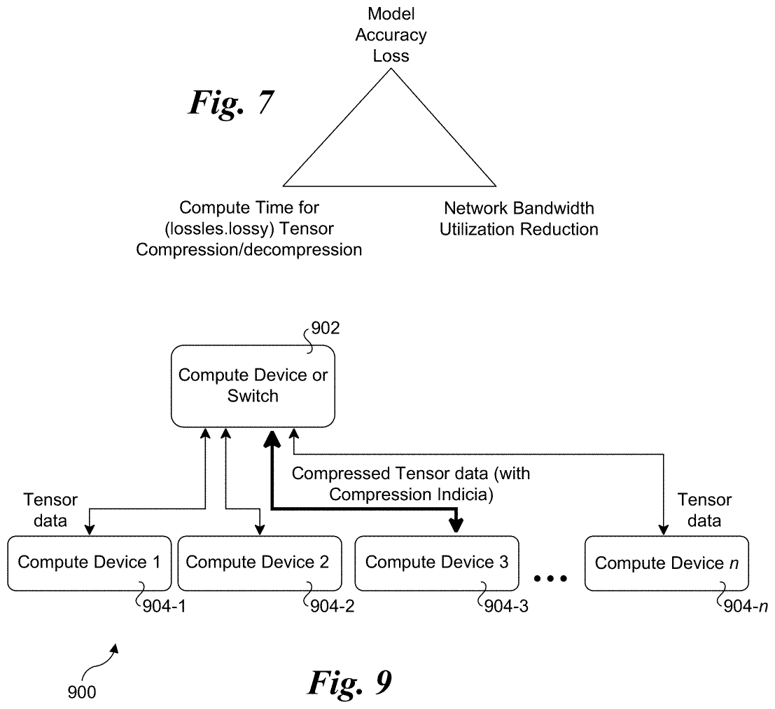

The variable compression techniques also consider cost/benefit tradeoffs. As shown in FIG. 7, compressing data to reduce the network traffic involves a trade-off between machine learning model accuracy loss, network bandwidth utilization reduction and the compute time required for the compression. For example, when the network pause time is greater than the compute time for data compression and the data compression will result in a slight reduction in accuracy, it is advantageous to use compression.

Under one aspect, lossy compression techniques are used. Under a lossy compression technique, the data before and after data compression and decompression are not the same, with the compresses/decompressed data having some loss for one or more attributes. For example, a common example of lossy compression is JPEG compression of images. Most JPEG compression algorithms are lossy, with the result being the pixel data following compression/decompression has less fidelity than the original image used as an input to the JPEG compression algorithm. In contrast, the Portable Network Graphic (PNG) image compression algorithm is non-lossy. An advantage of lossy compression algorithms is they are generally faster than non-lossy compression algorithms, and sometimes much faster.

Most ML and AI models employ 32-bit floating point data (aka Float32 or FP32). Under some embodiments herein the gradient descent data are compresses by converting Float32 data to 16-bit Brain floating point (Bfloat16 or BF16) data, a 16-bit floating point format for machine learning originally proposed by Google®. Some Processors, GPUs, and TPUs provide hardware support for BF16, supporting extremely fast data conversions from FP32 to BF16 and from BF16 to FP32. Such hardware includes but is not limited to Google® TPUs, Nvidia® GPUs, AMD®, and some Intel® and ARM®-based CPUs. In addition, CPUs, GPUs, and other ML/AI chips may be used in some embodiments, such as but not limited to AWS Trainium chips and Apple® CPUs and SoCs (e.g., M series chips).

Compression Trigger Logic

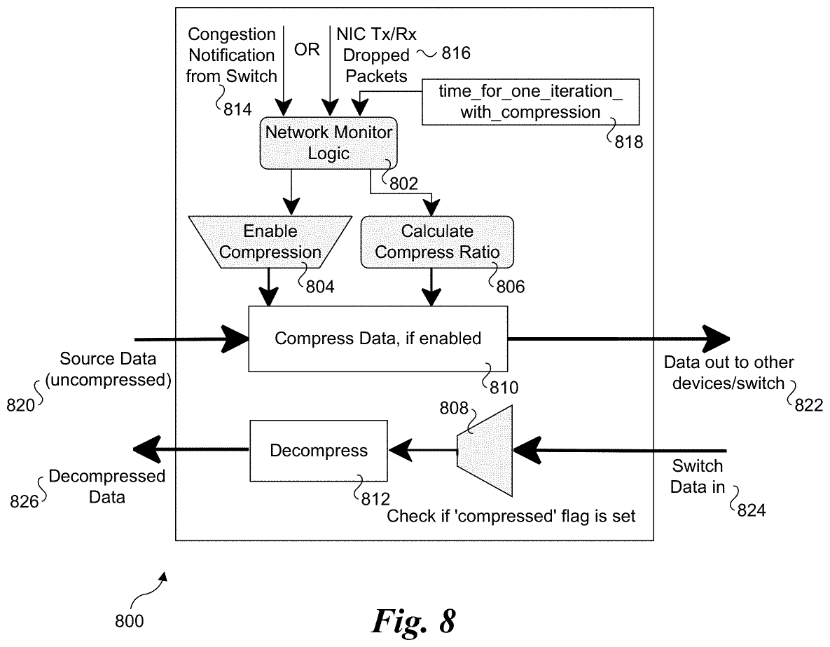

The general idea behind the compression triggering logic is that, if the network pause time due to congestion is calculated to be greater than compute time for compression, then it is beneficial for performance to invoke compression. A block diagram illustrating an embodiment of the compression trigger logic 800 is shown in FIG. 8, wherein the logic is implemented in the gray blocks. The logic includes network monitoring logic 802, an enable compression decision block 804, a compression ratio calculation block 806, and a compressed detection block 808. Additional components include a data compression block 810 and a data decompression block 812.

Network monitor logic 802 receives three inputs including congestion notifications from a switch 814, indicia 816 from a NIC Transmit (Tx) and/or Receive (Rx) logic relating to detection of dropped packets, and an amount of time_for_one_iteration_with_compression 818, whose calculation is discussed below. Based on these inputs, network monitor logic 802 determines whether compression should be enabled (enable compression decision block 804) an calculates a compression ratio in compression ratio calculation block 806 when compression is enabled. As further shown, data compression block 810 receives a compression enable output from enable compression decision block 804 and the compression ratio calculated by compression ratio calculation block 806 and compresses uncompressed source data

FIG. 9 shows an example of a system 900 including a compute device or switch 902 to which n compute devices 904-1, 904-2, 904-3 . . . 904-n are coupled via respective links. As illustrated, Tensor data is transmitted between the n compute devices and compute device or switch 902 over the links. In this example, compute device 904-3 has a congested link. In response to detection of the congested link, compute device 904-3 estimates the pause_time_history and sends compressed data with compression indicia comprising a ‘Compressed’ flag or multi-bit compression indicia identifying a compression type in the Tensor payload data. The receiving device (of the compressed Tensor data) will decode compression indicia and decompress the compressed Tensor data.

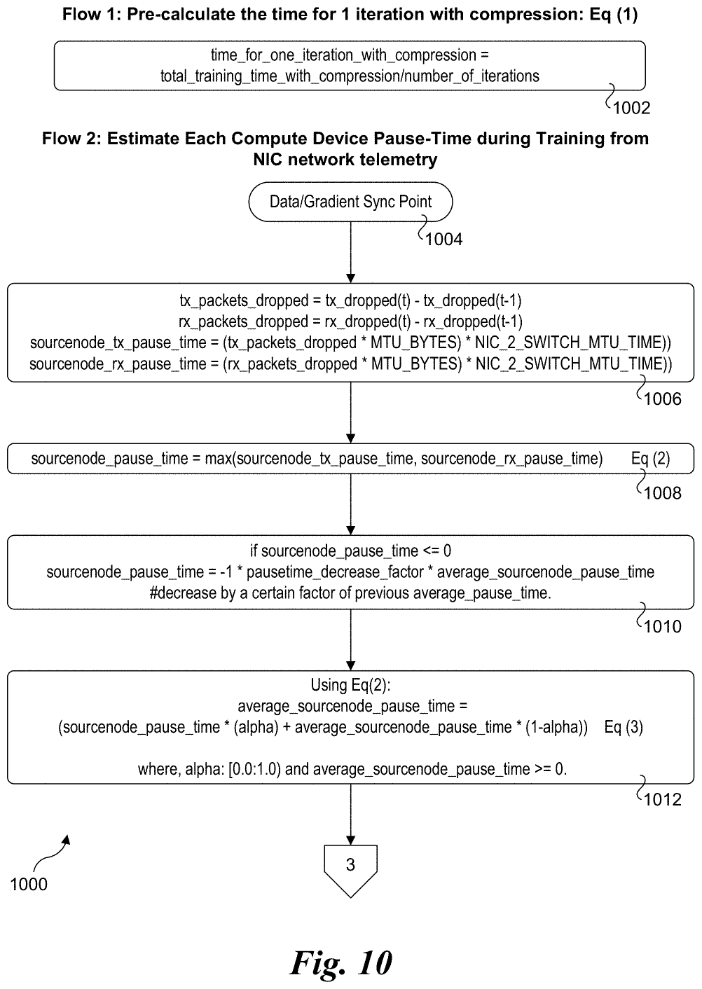

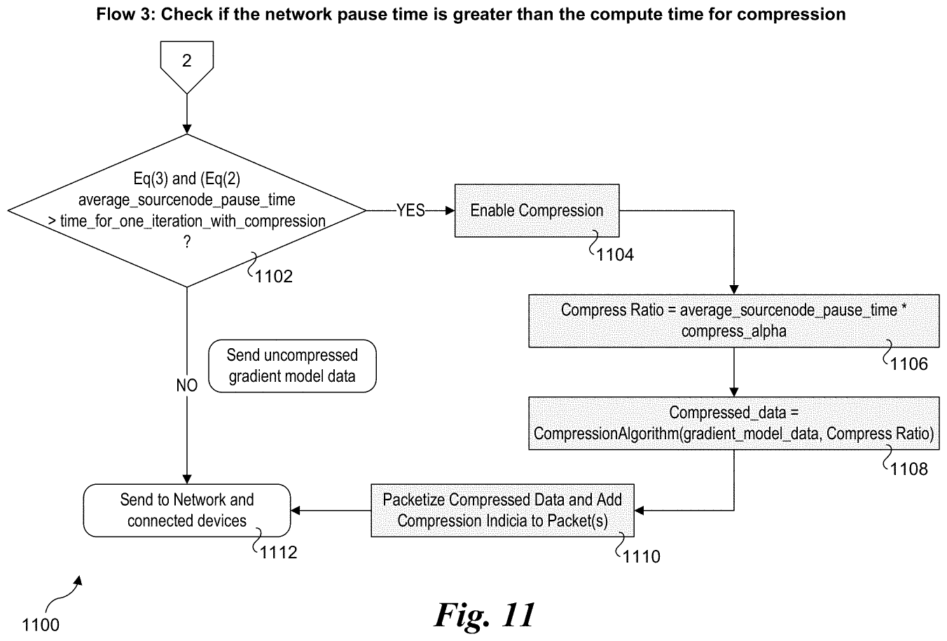

FIGS. 10 and 11 shown flow diagrams 1000 and 1100 illustrating operation performed by the compression trigger logic, according to one embodiment. The overall flow is divided into three flows: Flow 1, Flow 2, and Flow 3. The first Flow 1 is used to pre-calculate the time for one iteration with compression using Equation (Eq) (1). In a block 1002 the time_for_one_iteration_with_compression is calculated as the total training time with compression divided by the number of interactions (number of epochs) used for training a batch. The number of epochs may be a predetermined number or determined based on an error threshold, which may be determined empirically. With respect to the time_for_one_iteration_with_compression, this calculation can be from a theoretical model or estimated heuristically from multiple runs, where there is no congestion observed. For example, the time_for_one_iteration_with_compression for batch of images in one implementation of a resnet50 model is in 100 to 200 ms using a Habana® Gaudi® AI processor or Nvidia® GPUs.

Flow 2 is used to estimate the pause-time during training for each compute device (compute node) using NIC network telemetry. The process begins in a start block 1004 corresponding to a data/gradient sync point. In a block 1006 determinations are made to the number of transmit (Tx) packet dropped (tx_packets dropped) and receive (Rx) packets dropped (rx_packets dropped). tx_packets dropped is the number of outbound packets from the source that are dropped, as read from a NIC event counter for a given duration, ‘t’ (e.g., 2 milliseconds (ms)). Similarly, rx_packets dropped is the number of received packets received at the source that are dropped, as read from the NIC event counter for the same given duration ‘t’.

The source node transmit pause time (sourcenode_tx_pause_time) and the source node receive pause time (sourcenode_rx_pause_time) are then calculated, using the equations shown in block 1006. MTU_BYTES is the Maximum Transmission Unit in Bytes. NIC_2_SWITCH_MTU_TIME=MTU_BYTES/LINK_SPEED, wherein LINK_SPEED is the link bandwidth.

Next, in a block 1008 the source_node_pause time is determined as the maximum of the sourcenode_tx_pause_time and the sourcenode_rx_pause_time, which is identified as Equation 2. In a block 1010, a determination is made to whether the sourcenode_pause_time less than or equal to 0. If it is, the sourcenode_pause_time is decreased by a pause_time decrease factor times an average source_node_pause_time.

As shown in a block 1012, the average_sourcenode_pause_time is calculated using Equation (2) as:

$$( sourcenode\_pause \_time * ( alpha ) + average\_sourcenode \_pause \_time * ( 1 \text{-} alpha ) ) \qquad Eq ( 3 )$$

where alpha is between 0 and 1.0 and the average_sourcenode_pause_time>=0.

The flow then proceeds to Flow 3, as depicted by flow diagram 1100 in FIG. 11. During Flow 3 a check is performed to determine whether the network pause time is greater than the compute time for compression. This begins in a decision block 1102 where Equations (3) and (2) are used to determine whether the average_sourcenode_pause time is greater than the time for one iteration with compression. If the answer is YES, the logic proceeds to enable compression in a block 1104, followed by calculation of a compression ratio in a block 1106. As shown, the compress(ion) ratio is calculated as,

$$average\_sourcenode \_pause \_time * compress\_alpha$$

In a block 1108 compressed data are generated using a compression algorithm applied to the gradient model data (the Tensor data) and the compression ratio determined in block 1106. In a block 1110 the compressed Tensor data are packetized and compression indicia such as a ‘compress’ flag is added to the compressed Tensor data (e.g., in a packet header or encoded in the packet payload), and the compressed data is sent to the network and connected devices (destination compute nodes) in a block 1112. If the answer to decision block 1102 is NO, the gradient model data are sent uncompressed.

Example Switch

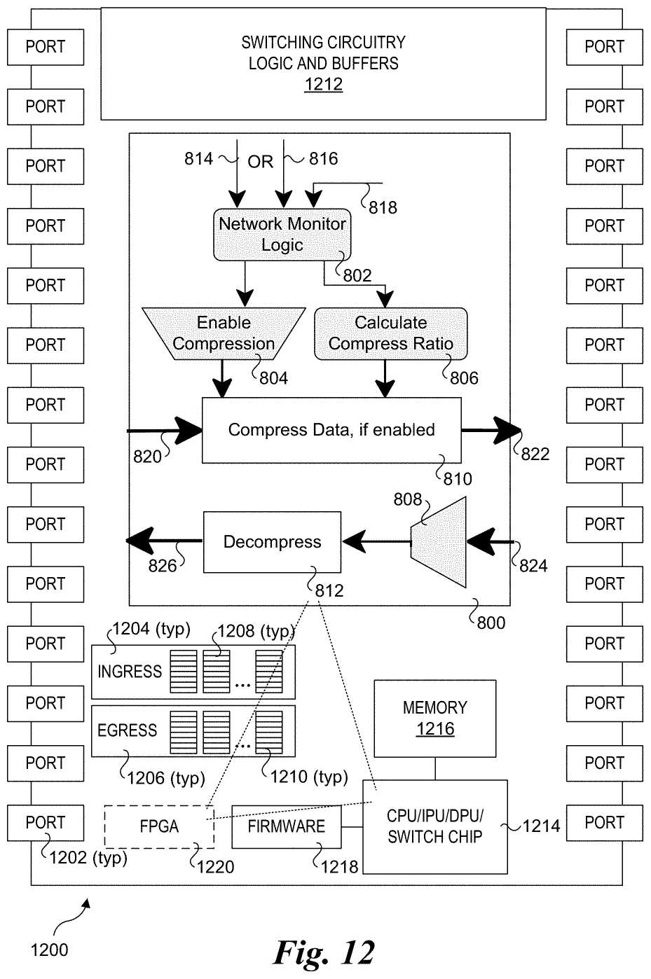

FIG. 12 shows a switch 1200 that may be implemented in some embodiments described and illustrated herein are implemented. Generally, switch 1200 employs conventional switch functionality while further adding the functionality employed by the embodiments disclosed herein. Accordingly, the description and illustrating of the conventional switch aspects are abstracted as the components and structures of conventional switches are well-known in the art and outside the scope of this disclosure.

Switch 1200 includes a plurality of IO ports 1202 that are configured to be coupled to a network or fabric. For example, if the network is an Ethernet network, IO ports 1202 are Ethernet ports and including circuitry for processing Ethernet traffic (e.g., Ethernet PHY and MAC circuitry). For a fabric, IO ports 1202 may employ applicable Host Fabric Interfaces (HFIs) or other types of fabric interfaces, noting that in the art the terms “network” and “fabric” are sometimes interchanged and have similar meaning. When switch 1200 is a CXL switch, IO ports 1202 are configured to support CXL interfaces and implement CXL protocols. When switch 1200 is a PCIe switch, IO ports 1202 are configured to support PCIe interfaces and implement PCIe protocols. Generally, IO ports 1202 may be configured to support networks or fabrics employing wired links (e.g., wired cable links or electoral traces on a printed circuit board or integrated circuit) or optical fiber links. In the latter case, IO ports 1202 may further include optical modules (not shown for simplicity).

In the illustrated embodiment, each IO port 1202 includes a set of ingress buffers 1204 and egress buffers 1206 (only one pair of which is shown for simplicity). The ingress and egress buffers may employ multiple receive queues 1208 and transit queues 1210. In one embodiment, switch 1200 supports QoS using different traffic classes, where some queues are allocated for different QoS levels (such as prioritized traffic associated with high bandwidth data). In some embodiments, one or more of the IO ports may have different structures and interfaces and may employ different protocols. For example, one or more ports may be used to connect to a management network or orchestrator.

The operation of switching functionality and associated ingress and egress buffer utilization is collectively shown via a switching circuitry logic and buffers block 1212. This would include, among other circuitry, switchable crossbar circuitry or the like to facilitate transfer of data from queues in ingress buffers to queues in egress buffers. It is noted the configuration of the ingress and egress buffers is illustrative and non-limiting. As is known in the art, there will be relatively small ingress and egress buffers at each IO port and there may either be separate ingress and egress buffers or separate shared buffers in memory on the switch. Generally, the actual packets are not buffered in the ingress and egress queues but rather these queues contain packet metadata along with a pointer to where the packet associated with the packet metadata for a given packet is buffered in memory. In this case, metadata, such as packet headers may be inspected and, optionally, updated, and the metadata are effectively moved between ingress and egress queues by copying the metadata from an ingress queue to an egress queue. Subsequently, the metadata that were copied will be overwritten by metadata for new received packets in the ingress queue.

Switching circuitry logic and buffers block 1212 may also include logic for implementing Layer 3 and above functionality, in some embodiments (such as traffic classification for QoS and other purposes, detecting invalid packets, etc.). As further shown, switch 1200 includes circuitry and logic for implementing compression trigger logic 800 illustrated in FIG. 8 as discussed above.

The various logic and data structures shown and described herein may be implemented on a switch using appropriate embedded logic and circuitry. Such embedded logic may be implemented via execution of software/firmware on one or more processing elements, implementation of hardware-based logic such as preprogrammed logic (e.g., ASICs) and/or programmable logic (e.g., one or more FPGAs), or a combination of the two. In one embodiment, switch 1200 includes one or more CPUs or SoCs coupled to memory. In one embodiment, switch 1200 employs an IPU or DPU SoC chip that includes a plurality of processor cores in combination with FPGA circuitry. In addition, there is switch circuitry produced by various manufacturers such as switch chips that may be used for the conventional switching aspects of switch 1200. In one embodiment, CPU or SoC 1214 comprises a switch chip that implements to functionality ascribed to compression trigger logic 800 in addition to conventional switch chip functionality.

In the illustrated example, switch 1200 includes a CPU/IPU/DPU/Switch Chip 1214 coupled to memory 1216 and a firmware storage device 1218. Switch 1200 may also include an FPGA 1220 in some embodiments. In cases where CPU/IPU/DPU/Switch Chip 1214 is an IPU or DPU, the IPU or DPU may include one or more embedded FPGAs. In one embodiment, the IPU is an Intel® IPU, such as but not limited to a Mount Evans IPU chip, which includes a multi-core CPU, on-chip memory controllers, and an FPGA that may be programmed for performing various packet processing operations.

Firmware storage device 1218 stores firmware instructions/modules that are executed on one or more cores in CPU/IPU/DPU/Switch Chip 1214 to effect the functionality of all or a portion of compression trigger logic 800. The firmware instructions are loaded into memory 1216 and executed, with applicable data structures data structures being stored in memory 1216. Optional FPGA 1220 may also be programmed to implement the functionality (in whole or in part) of compression trigger logic 800. For example, FPGA 1220 may be used to implement data compression block 810 and data decompression block 812.

In some embodiments, a CPU or XPU may include an instruction set architecture (ISA) that includes one or more instructions for performing conversion between numerical formats. For example, in some embodiment compression is implemented by converting FP32 values to Bfloat16 values, with decompression converting Bfloat16 values back to FP32 values. The CPU/XPU may include ISA instructions for performing the conversion or may have a program library used for such conversions that may employing multiple ISA instructions to effect the conversion. As discussed above, Bfloat16 is a non-limiting example of a numerical format used in some embodiment, as other compression/decompression schemes may also be employed.

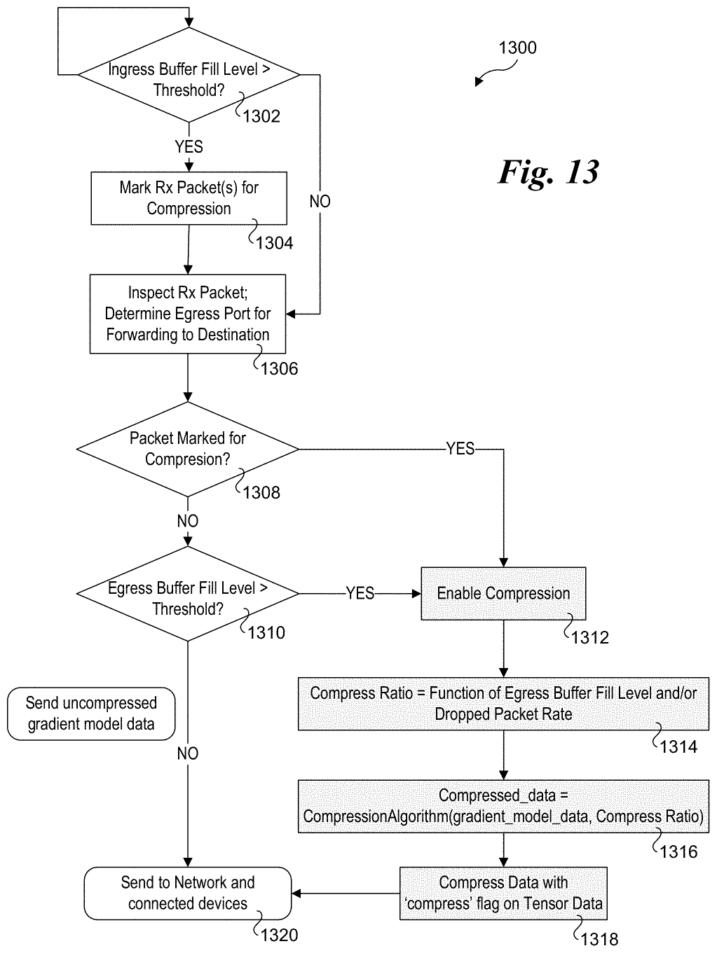

FIG. 13 illustrate a flowchart 1300 illustrating operations and logic implemented at a switch for selectively compressing Tensor data. As shown in a decision block 1302, a determination is made to whether an ingress buffer level has reached a threshold. As depicted by the loop back to itself, the determination in decision block 1302 is performed on an ongoing basis. In some embodiments, received (Rx) packets will be initially buffered is a ingress port buffer and then copied to an ingress buffer with the packet header and/or other metadata being added to an ingress queue entry. The ingress buffer fill level may be detected by monitoring the ingress queue levels. While packet sizes may vary, large data transfers such as used for exchanging local gradient data will use MTU packets (packets having the MTU size).

When an ingress fill level is determined to reach the threshold, the answer to decision block 1302 is YES and the logic proceeds to a block 1304 in which the Rx packet(s) exceeding the threshold are marked for compression. Under optional embodiments, any of the packet, packet header, or packet metadata are marked.

Following block 1304 or if the answer to decision block 1302 is NO, the Rx packet will be inspected in a block 1306, and a determination to what egress port is to be used to transmit the packet to the next hop to reach the destination compute node is made. Generally, the destination address for the packet (corresponding to the network/fabric address for the destination compute node) will be in the packet's header, and the switch may employ a routing/forwarding table or the like to determine the appropriate egress port to be used for the next hop. When the destination compute node is coupled to the switch, the egress port will be the port on the switch to which the compute node is directly coupled via a network or fabric link.

In a decision block 1308 a determination is made to whether the packet is marked for compression. If it is, the answer is YES and the logic proceeds to a block 1312 in which compression is enabled. If the answer is NO, a determination is made to whether the egress buffer fill level for the egress port that is identified exceeds a threshold. If it does, answer is YES and the logic proceeds to enable compression in block 1312.

In a block 1314 a compression ratio is determined as a function of the egress buffer fill level and/or a dropped packet rate. Telemetry data for dropped packet as well as for buffer/queue fill levels may be maintained. Generally, the higher the egress buffer fill level is above the fill level threshold and or the higher the packet drop rate the higher the compression ratio. In blocks 1316 and 1318 the packet is compressed using an applicable compression algorithm along with the compression ratio and a ‘compress’ flag is added/marked in a similar manner to blocks 1108 and 1110 discussed above. The packet with the compressed data is then transmitted out the egress port, as shown in a block 1320. If the packet is not marked for compression and an egress buffer fill level threshold is not exceeded the packed is transmitted out the egress port without compression.

Distributed processing may generally use one or more libraries that designed for such purposes. One non-limiting example is a Message Passing Interface (MPI) library. MPI employs a number of collective message formats including an MPI_Bcast that is used to broadcast data to nodes or “ranks” in the distributed environment. Other types of broadcast messages employ a similar paradigm. The MPI-Bcast message may be associated with an MPI_COMM_WORLD communicator that defines the node/ranks participating in the distributed environment. Other types of broadcast messages employ a similar paradigm. For example, conventional network broadcast messages, such as used for IP broadcasting, employ a broadcast group that comprises a set of IP address to which the broadcast message is to be delivered.

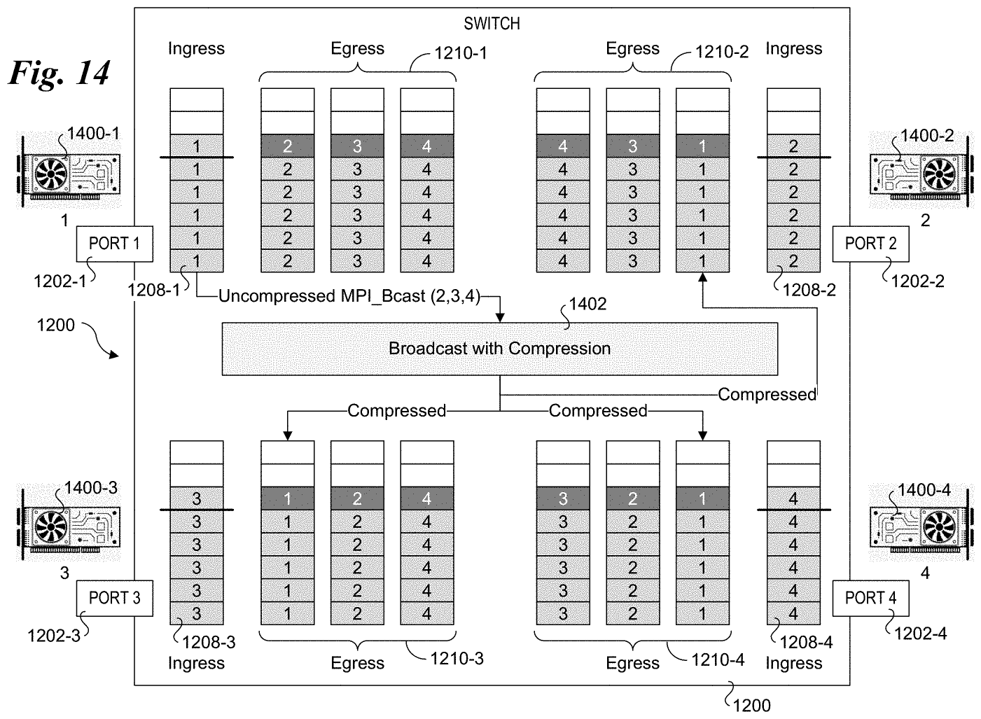

FIG. 14 shows an example of message broadcasting using selective compression. The environment includes four compute nodes 1400-1, 1400-2, 1400-3, and 1400-4 connected via respective links (not shown) to respective TO ports 1202-1, 1202-2, 1202-3, and 1202-4 on switch 1200, which are also labeled nodes 1, 2, 3, and 4, and Ports 1, 2, 3, and 4. Each of these TO ports is depicted as including a respective ingress queue 1208-1, 1208-2, 1208-3, and 1208-4 and a respective set of three egress queues 1210-1, 1210-2, 1210-3, and 1210-4. The number of ingress queues and egress queues are for illustrative purposes for this example, as an actual implementation may have a different number of ingress and egress queue per TO port.

In this example presume that the traffic that is handled by switch 1200 is only traffic from distributed processing of a ML/AI model and we are just after the start of a sync operation. As this stage, ingress queue 1208-1 has 6 packets received from compute node 1, ingress queue 1208-2 has 6 packets received from compute node 2, ingress queue 1208-3 has 6 packets received from compute node 3, and ingress queue 1208-4 has 6 packets received from compute node 4.

In connection with a broadcast operation, packets are copied from an ingress queue to multiple egress queues based on the broadcast group (or in the case of MPI_Bcast based on the nodes/ranks specified in the associated MPI_COMM_WORLD communicator). In this example consider packets (packet metadata) that are buffered in ingress queue 1208-1. Each of these packets/metadata will be copied to an egress queue for each of Ports 2, 3, and 4, as shown. Similar copying of packets/metadata would be used for packets/metadata buffered in the other ingress queues 1208-2, 1208-3, and 1208-4.

In a manner similar to that described and illustrated by flowchart 1300, switch 1200 can perform selective compression based on switch telemetry data such as ingress and egress queue levels exceeding threshold and/or dropped packet data. An example of this compression is performed by a broadcast with compression block 1402, which begins compressing packet data for packets that are above a threshold of 5 packets in each of ingress queues 1208-1, 1208-2, 1208-3, and 1208-4, wherein compressed packets are shown with a white number over a dark gray background.

With respect to different packet buffering implementations, there are various schemes for compressing packet data. Under a shared buffer approach under which a given packet is buffered in a shared buffer on a switch that operates (in effect) as both an ingress and egress buffer, the packet data may be compressed in place under which the original packet payload data are read from the buffer, compressed, and then written back to the buffer following the packet header so as to replace the original packet payload data. The (now) compressed packet is subsequently copied to an applicable egress port buffer. For a buffering scheme using both ingress and egress buffers, the packet payload data are read from the ingress buffer, compressed, and then written to an egress buffer as a compressed packet. The compressed packet is subsequently copied to an applicable egress port buffer. A similar approach may be used for the shared ingress/egress buffer scheme where the packet payload data are read from the shared buffer, compressed, and then written to an applicable egress port buffer. One advantage of the copy in place scheme is that it can be done earlier, observing the size of a shared buffer will generally be significantly larger than the size of an egress port buffer.

Under an alternative switch embodiment, ingress and/or egress buffer/queue thresholds are used to trigger additional logic that is then used to determine whether to apply compression. Pseudocode for one embodiment is shown in LISTING 1 below:

LISTING 1

| | |
|---|---|
| 1. | Check the time that the switch exceeds a given buffer_threshold: |

```
If switch_buffer > buffer_threshold_const,
  Switch_wait_time++
Else,
  Switch_wait_time =0
```

| | |
|---|---|
| 2. | Check if the switch_wait_time is greater than the time for |
| | compressions. {compression_time_const and |
| | buffer_threshold_const are tunable parameters) |

```
If switch_wait_time > compression_time_const,
  Enable_compression = True
Else
  Enable_compression = False
```

In accordance with the first pseudocode function, when a buffer/queue threshold is exceeded, a switch wait time is periodically increased, such as every 1-2 ms, for example. Under the second pseudocode function, when the switch wait time exceeds the preset compression time compression is enabled. Both the compression time and buffer thresholds are tunable parameters.

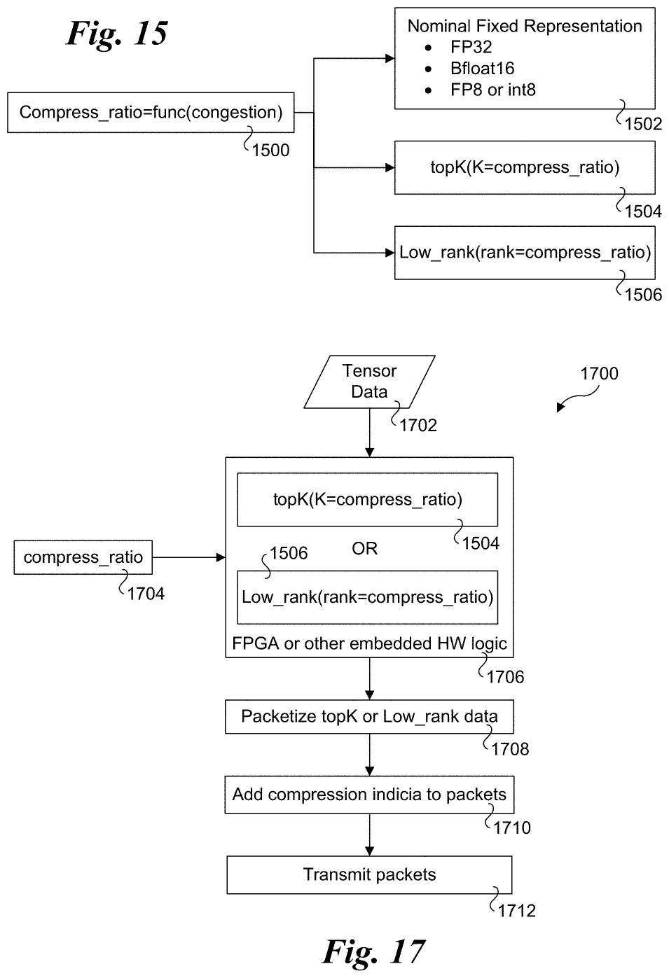

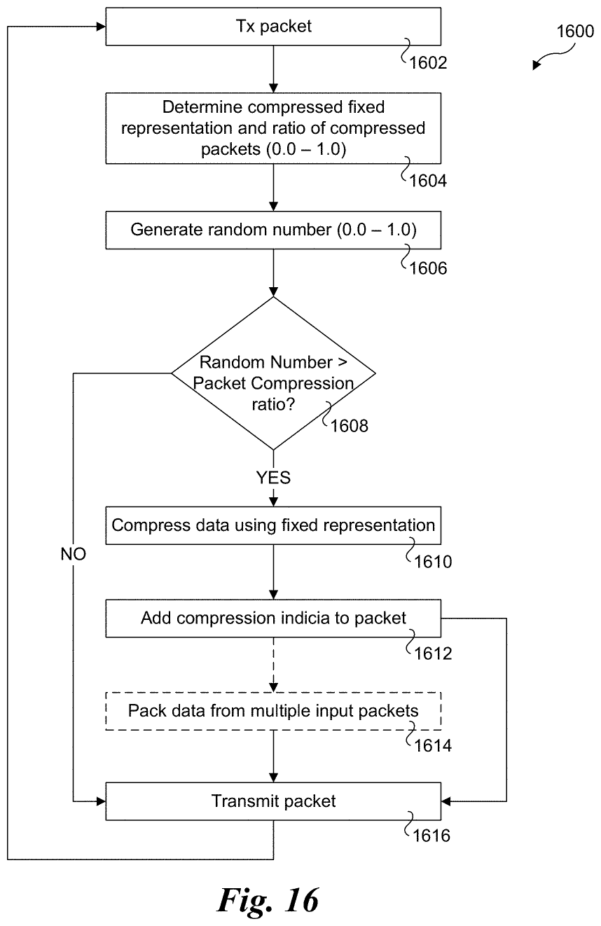

FIG. 15 shows a diagram illustrating selection of a compression function/scheme, according to one embodiment. In block 1500 a compression ratio is determined as a function of detected/determined congestion in the network or fabric. Based on the compression ratio that is determined (and/or other considerations not shown), the logic may select to send the Tensor data using a nominal fixed representation, such as shown by FP32, Bfloat16, and FP8 or int8 in a block 1502. These are non-limiting examples of fixed representation data. Compression using fixed representation data are described below with reference to FIG. 16.

As an option, in some embodiments the use of topK and/or Low rank compression schemes may be used, where topK and/or Low rank compression is performed in hardware on the fly in a manner that does not involve changes to the ML/AI models are algorithms. Under both topK and Low rank, the amount of Tensor data may be substantially reduced. Both of these schemes are known in the art and implementation of a particular version of topK or Low rank is outside the scope of this disclosure.

FIG. 16 shows a flowchart 1600 illustrating operations and logic for implementing compression using fixed representation with a compression ratio. Generally, this approach may be applied to any fixed representation of numerical data, wherein the fixed representation results in less data (to be transmitted) than an original format of Tensor data generated and used by the ML/AI model.

The processing loop begins with a Tx packet 1602 to be transmitted. In a block 1604 a determination is made to identify the fixed representation to be used and a ratio of compressed packets for which the fixed representation compression is to be applied. In the illustrated example the ratio of compress packets is between 0.0 and 1.0 (0-100%). Under this approach, the ratio of compressed packets and the resulting compression ratio of the data are related but they are not one in the same.

In a block 1606 a random number is generated between 0.0 and 1.0. Generation of random numbers is well-known, and the particular implementation is outside the scope of this disclosure. Pseudorandom number generators may be used. The output of a pseudorandom number generator may be normalized to be between 0.0 and 1.0.

In a decision block, a determination made to whether the random number is greater than the packet compression ratio determined in block 1604. When it is, the data are compressed using the fixed representation in a block 1612 and applicable compression indicia (e.g., value in a reserved header field or flag) is added/marked in a block 1612. The packet with the compressed data is then transmitted in block 1616. When the random number is less than or equal to the packet compression ratio, the answer to decision block 1608 is NO and the logic proceeds to transmit the packet in block 1616 without compression. The logic then loops back to block 1602 to process the next Tx packet.

In an optional block, data from multiple input Tx packets may be packed into a single packet, such as for MTU packets. This may be applied to fixed representations that result in compression ratios of 2:1 or greater. Under this flow, the logic may operate on multiple packets at a time, rather than a single Tx packet.

The result of the operations and logic in flowchart 1600 produces a ratio of compressed packets as a function of any of 1) a compression ratio input (to the flow); 2) a compression ratio input plus a ratio of packets to compress input; or 3) a fixed representation input (defining what fixed representation to use) and a ratio of packets to compress input. For example, suppose the compression ratio is 20% and the fixed compression is 32FP->Bfloat16 with data packing. This result can be obtained by compressing 10% of the packets. Thus 1/10^{th} of the packets would contain Bfloat16 data while the other 9/10^{th} of the packets would be transmitted using FP32 data.

FIG. 17 shows a flowchart 1700 illustrating operations for implementing topK or Low rank compression in-line as part of the Tensor data exchange. The process operates on Tensor data 1702 as a function of an input compression ratio 1704. A topK or Low rank compression algorithm is implemented in a block 1706 using embedded hardware logic such as but not limited to an FPGA, other programmable or fixed logic (e.g., ASIC) or execution of embedded software/firmware on an embedded processor. Notably, the topK or Low rank compression algorithm is not implemented by the ML/AI model or its implementation on the compute nodes in software.

In a block 1708 topK or Low rank data generated in block 1706 are packetized into one or more packet. In a block 1710 applicable compression indicia is added to the packets (such as but not limited to a multi-bit value or flag in the packet header), and the packets are transmitted in a block 1712.

It is further noted that as another option FP32 data may be compressed using a known floating point compression algorithm, such as but not limited to fpzip. More generally, any type of compression algorithm or scheme may be used the results in 1) change in format of the data; and 2) where the amount of data in the format after compression is less than the amount of data prior to compression. Both lossy and lossless compression algorithms may be used. In some embodiments the Significand (which may also be referred to as the Mantissa) is reduced in the compressed format.

In addition to distributed ML/AI model training using data parallelism, distributed ML/AI model training using model parallelism is also supported by the principles and teachings disclosed herein. Under model parallelism, different compute nodes are used to implement respective portions of an ML or AI deep learning model. For example, a first portion of ANN layers of the model are implemented by a first compute node, a second portion of the ANN layers are implemented by a second compute node, etc. As with data parallelism, the compute nodes will periodically exchange Tensor data with one another and update their local weights.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (e.g. stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. An apparatus comprising circuitry and logic to:
receive network telemetry data relating to congestion in a network or fabric to which a plurality of compute nodes is coupled, the compute nodes performing distributed training of an Artificial Intelligence (AI) model that includes exchanging Tensor data amongst the plurality of compute nodes; and
determine whether to selectively compress Tensor data generated by the plurality of compute nodes in consideration of the network telemetry data.

2. The apparatus of claim 1, further comprising a data compression block to compress Tensor data, wherein circuitry and logic are configured to:
determine, as a function of the telemetry data, a network pause time;
determine, for Tensor data to be exchanged between at least two of the plurality of compute nodes, a compute time to compress the Tensor data; and
selectively compress the Tensor data when the compute time is less than the network pause time.

3. The apparatus of claim 2, wherein the network pause time is determined as a function of network telemetry data comprising a transmitted packet drop rate.

4. The apparatus of claim 2, further comprising:
circuitry and logic to calculate a compression ratio to be applied to compress Tensor data,
wherein the data compression block includes a compression ratio input that is applied when compressing Tensor data.

5. The apparatus of claim 4, further comprising:
a compressed detection block to detect presence of compression indicia in Tensor data received by the apparatus identifying a compression type; and
a data decompression block, configured to decompress received compressed Tensor data when the compressed detection block detects presence of the compressed indicia.

6. The apparatus of claim 5, wherein the circuitry and logic are embedded in an integrated circuit comprising one of a Central Processing Unit (CPU), Graphics Processing Unit (GPU), Tensor Processing Unit (TPU), an AI processor, AI inference unit, an Infrastructure Processing Unit (IPU) and a Data Processing Unit (DPU).

7. The apparatus of claim 4, wherein the circuitry and logic are implemented in a network switch chip.

8. The apparatus of claim 4, wherein the circuitry and logic are implemented in a network switch, and wherein the circuitry and logic are further configured to selectively compress Tensor data in packets received at the network switch and broadcast the packets via a plurality of transmit ports.

9. The apparatus of claim 1, wherein the circuitry and logic include network monitor logic having multiple inputs including one or more of a network telemetry data input and congestion notification input.

10. The apparatus of claim 1, wherein the apparatus comprises one of the plurality of compute nodes.

11. A method for training an Artificial Intelligence (AI) model, comprising:
implementing respective instances of the AI model on a plurality of compute nodes interconnected via a network or fabric;
processing respective batches of training data with the respective instances of the AI model at the respective compute nodes, the processing including calculation of local model gradient data;
exchanging local model gradient data amongst the plurality of compute nodes by transmitting the local model gradient data via the network or fabric; and
updating local weights in the instances of the AI model on the plurality of compute nodes,
wherein the local model gradient data are exchanged by applying selective compression to the local model gradient data in consideration of network or fabric congestion.

12. The method of claim 11, wherein the network or fabric comprises one or more switches to which the plurality of compute nodes are coupled to via a plurality of links, the method further comprising:
detecting there is congestion on a link; and
in response thereto,
compressing local model gradient data generated at a source compute node coupled to the link; and
sending the compressed local model gradient data over the link.

13. The method of claim 11, wherein the network or fabric comprises one or more switches to which the plurality of compute nodes are coupled to via a plurality of links, the method further comprising:
at a switch,
receiving a packet containing local gradient data via a first link from a first compute node and having a second compute node as a destination;
determining there is congestion on a second link used to forward the packet to the second compute node; and
compressing the local gradient data in the packet prior to forwarding the packet via the second link to the second node.

14. The method of claim 11, wherein the network or fabric comprises one or more switches to which the plurality of compute nodes are coupled to via a plurality of links, the method further comprising:
at a switch,
receiving a packet containing local gradient data via a first link from a first compute node, the packet associated with a broadcast message associated with a broadcast group comprising a plurality of destination compute nodes;
determining there is congestion on a second link used to forward the packet to a destination compute node among the plurality of destination compute nodes in the broadcast group; and
compressing the local gradient data in the packet prior to forwarding the packet via the second link to the destination compute node.

15. The method of claim 14, further comprising:
determining transmit ports on the switch to be used for forwarding the local gradient data to the plurality of destination compute nodes in the broadcast group; and
copying a packet containing compressed local gradient data to egress buffers associated with the transmit ports.

16. The method of claim 11, further comprising:
detecting there is congestion on a link; and
in response thereto,
determining an amount of pause time that would be employed at a source node without compression is greater than an amount of compute time for compressing the local gradient data;
compressing local model gradient data generated at a source compute node coupled to the link prior to sending the compressed local model gradient data over the link.

17. The method of claim 11, further comprising:
detecting there is network congestion for a link by at least one of,
detecting a rate of dropped packets for packets transmitted from a source compute node via the link; and
detecting a rate of dropped packets for packets received at the source compute node via the link.

18. The method of claim 11, further comprising
determine, as a function of network telemetry data, a network pause time;
determine, for local gradient data generated on a source compute node to be sent over the network or fabric to one or more destination compute nodes, a compute time to compress the local gradient data; and
selectively compressing the local gradient data when the compute time is less than the network pause time.

19. The method of claim 11, wherein the AI model uses 32-bit floating point numerical data (FP32), and compression comprises converting the FP32 data to 16-bit Brain floating point (Bfloat16) data.

20. A system for training an artificial intelligence (AI) model, comprising a plurality of compute nodes interconnected via a network or fabric, a compute node comprising at least one processor coupled to memory and a network or fabric interface coupled to the network or fabric, the plurality of compute nodes configured to:
implement respective instances of the (AI) model at respective compute nodes;
process respective batches of training data with the respective instances of the AI model at the respective compute nodes, the processing including calculation of local model gradient data;
exchange local model gradient data amongst the plurality of compute nodes by transmitting the local model gradient data via the network or fabric; and
update local weights in the instances of the AI model on the plurality of compute nodes,
wherein the local model gradient data are exchanged by applying selective compression to the local model gradient data in consideration of network or fabric congestion.

21. The system of claim 20, wherein the network or fabric comprises one or more switches to which compute nodes are coupled to via a plurality of links, the system further configured to:
detect there is congestion on a link; and
in response thereto,
compress local model gradient data generated at a source compute node coupled to the link; and
send the compressed local model gradient data over the link.

22. The system of claim 21, wherein the system is further configured to:
determine a compression ratio to be applied to the compressed local model gradient data; and
compress the local model gradient data with the compression ratio that is determined.

23. The system of claim 20, wherein the network or fabric comprises one or more switches to which compute nodes are coupled to via a plurality of links, the system further configured to:
monitor network telemetry data;
determine, as a function of network telemetry data, a network pause time;
determine, for local gradient data generated on a source compute node to be sent over the network or fabric to one or more destination compute nodes, a compute time to compress the local gradient data; and
selectively compress the local gradient data when the compute time is less than the network pause time.

24. The system of claim 20, wherein the plurality of compute nodes comprise multiple processors interconnected via a plurality of input-output (TO) interconnects, wherein the multiple processors comprise one or more of Graphic Processor Units (GPUs), Tensor Processing Units (TPUs), Data Processor Units (DPUs), Infrastructure Processing Units (IPUs), AI processors, AI inference units, and Field Programmable Gate Arrays (FPGAs).

25. The system of claim 20, wherein the plurality of compute nodes comprise a plurality of servers installed in a rack including a switch to which the plurality of servers are communicatively coupled.
